(19) United States
(12) Patent Application Publication
(10) Pub. No.: US 2011/0035431 A1
(43) Pub. Date: Feb. 10, 2011

(54) Dissemination of Information In an Intermittent Network Connectivity

(75) Inventors: John N. Geary, Wayne, PA (US); Timothy E. Dilworth, Saint Davids, PA (US); Jeffrey P. Kase, Bar Harbor, ME (US)

Correspondence Address: FOX ROTHSCHILD LLP, 997 Lenox Drive, Bldg. #3, Lawrenceville, NJ, 08648, US

(73) Assignee: GUTTAPERCHA PARTNERS, INC., Bryn Mawr, PA (US)

(21) Appl. No.: 11/579,438

(22) PCT Filed: May 13, 2005
(86) PCT No.: PCT/US2005/016868

§ 371 Date: Jan. 9, 2008

Related U.S. Application Data
(60) Provisional application No. 60/571,601, filed on May 13, 2004.
(60) Provisional application No. 60/571,024, filed on May 14, 2004.

(51) Int. Cl. G06F 15/16

(52) U.S. Cl. 709/203

(57) ABSTRACT

The present invention provides a system and method for dissemination of information to a device in an environment in which network connectivity is intermittent. This is particularly useful in dissemination of information to PDA devices via a wireless connection, which may be unreliable and/or intermittent. Further, the method is particularly useful in dissemination of information to most PDA devices, which have operating environments that are particularly weak with respect to error recovery and exception handling capabilities, resulting in application crashes when there is a lack of network connectivity, even if temporary. The method involves receiving externally-stored network content via a wireless connection, converting references to externally-stored network content to references to locally-stored content, and storing the converted content as locally-stored content. The method may further include monitoring the externally-stored network content for updates, and updating the locally-stored content accordingly.

### FIELD OF THE INVENTION

The present invention relates to dissemination of information in a controlled-access environment, such as the grounds of a golf course during a professional golf tournament. The invention further relates to software for disseminating information via a wireless communication device.

### DISCUSSION OF RELATED ART

There are various examples of controlled-access environments for which a person's admittance to the environment is controlled by an authority. Such controlled access environments include amusement parks, sports stadiums or other forums, concert arenas, airports, movie theaters, conference halls, etc. The authority determines whether a person will be admitted to the environment, and/or imposes rules regarding admission to, or behavior within, the environment. Such authorities often impose rules forbidding admission of a person carrying a wireless communication device, such as a wireless telephone, personal digital assistant or pocket PC (collectively “PDA”) device, pager, etc., or rules forbidding operation of such wireless communication devices within the controlled-access environment. Such devices are often prohibited because it is believed that their use within the controlled-access environment will disturb others within the same environment.

Nevertheless, commercial entities and consumers alike have recognized the desirability of dissemination and receipt of information via such wireless communication devices, many of which are presently configured for Internet and World Wide Web (collectively “Web”) access and/or to receive other wireless communications. Additionally, there is often a considerable amount of information available via the Web that relates to such controlled-access environments or events occurring within such environments. However, such information is unavailable to persons within such environments when use of such wireless communication devices therein is forbidden.

For example, the Professional Golfers Association of America (PGA) is an authority that hosts, organizes and/or sponsors professional golf tournaments at various golf courses throughout the United States. When a professional golf tournament is in progress on golf course grounds, the PGA prohibits admission of persons onto the grounds with a wireless communication device; typically such devices are “checked” at the entrance gate to ensure that spectators and/or players are not disturbed by telephone ring tones, beeps, chirps, and other noises made by such devices. This deprives admitted persons of various wireless communications, including real-time scoring updates and other tournament play information delivered via the PGA's Web-accessible TourCast information service (accessible via URL http://www.pgatour.com). As a result, persons on the golf course grounds are typically less informed of tournament play than others monitoring the tournament from a remote location via the Web, radio, television, etc. This lack of information is compounded by the behavior of spectators at a PGA tournament in that most spectators either follow a single player from hole to hole, or remain stationary on the course and observe tournament play as various players play the nearest hole. Meanwhile, play occurs concurrently at multiple holes. Accordingly, it is difficult for spectators to observe multiple players, at multiple holes on the golf course grounds.

A further difficulty in disseminating and receiving information via wireless communication devices at public events is that the local wireless infrastructure, and the web server(s) providing information concerning the event, may become overloaded by the quantity of users attempting to connect and the quantity of data that may be contained on a web page. Users may accordingly become frustrated at delays associated with the poor quality of service that may result from such overloading. Indeed, a user's wireless communication devices may even malfunction as a result of such delays. A factor contributing to this problem of overloading is that existing web browsers for wireless communication devices lack the capability to update “dynamic” content on a web page (e.g., the current score at a sporting event), without downloading a new copy of the entire web page.

### SUMMARY

The present invention provides a system and method for dissemination of information to a device in an environment in which network connectivity is intermittent. This is particularly useful in dissemination of information to PDA devices via a wireless connection, which may be unreliable and/or intermittent. Further, the method is particularly useful in dissemination of information to most PDA devices, which have operating environments that are particularly weak with respect to error recovery and exception handling capabilities, resulting in application instability or “crashes” when there is a lack of network connectivity, even if temporary. The method involves receiving externally-stored network content via a wireless connection, converting references to externally-stored network content to references to locally-stored content, and storing the converted content as locally-stored content. The method may further include monitoring the externally-stored network content for updates, and updating the locally-stored content accordingly.

A device configured to disseminate information in accordance with the method is provided. The device includes a microprocessor, a memory operatively connected to the microprocessor, e.g. for communication via wireless transmission, a data transmission port operatively connected to the microprocessor, and computer-readable instructions stored in the memory and executable by the microprocessor to carry out the method described above. Also provided is a system including the device described above, a server storing information content for dissemination to the device, and an antenna in communication with the server and the device for transmitting such information from the server to the device via wireless transmission.

A PDA-based customized browser application configured in accordance with the present invention has the following advantages over existing PDA-based browsers. First, the browser can function regardless of whether it is connected to the host server. Second, it allows the user to navigate through a web site in a reasonably responsive manner. Third, it is able to update the data on certain pages in a timely manner when connected. Fourth, if a connection to the host server is not available, it displays the most-recently retrieved data, without an application. Fifth, it works on currently available PDA devices, within existing constraints of memory, CPU power and battery life.

### DESCRIPTION OF THE DRAWINGS

The present invention will now be described by way of example with reference to the following drawings in which:

FIG. 1 is a block diagram of an exemplary system and environment in which the invention may be employed;

FIG. 2 is a flow diagram illustrating an overview of an exemplary method for dissemination of information in a controlled-access environment in accordance with an exemplary embodiment of the present invention;

FIG. 3A is a plan view of an exemplary device in accordance with the present invention;

FIGS. 3B and 3C are plan views of the device of FIG. 3A, with portions removed for illustrative simplicity; and

FIG. 4 is a block diagram of the exemplary device of FIGS. 3A-3C.

FIG. 5 is a block diagram of a preferred embodiment of an exemplary system in accordance with the present invention.

FIGS. 6-10 are flow charts illustrating an exemplary method for receiving, storing and updating internet content on a wireless communication device having a network connection, in accordance with the present invention.

### DETAILED DESCRIPTION

In one aspect, the present invention provides a method for dissemination of information in a controlled-access environment that provides individuals in the environment with information delivered via wireless transmission while enabling an authority to maintain control over dissemination of the information and/or use of wireless communication devices within the environment.

According to another aspect, the present invention causes event attendees to use wireless communications devices controlled by the authority, and the authority can thereby control how such devices are configured and/or used within the environment, e.g. to ensure operation in accordance with the authority's rules. Accordingly, the present invention provides a device that can be used to ensure avoidance of ring tones, beeps, chirps and other noises that could be disruptive to others, including professional golf players during a golf tournament, while providing for certain environment-specific features that are advantageous. Furthermore, the authority's control over the wireless communication devices allows for use of the such devices as an advertising medium controlled by the authority. Further, the device may be used to sell merchandise to users, using, e.g., a user's previously stored credit card or account number. Such merchandise may be delivered to a user either at a specific location near the controlled-access environment, or delivered after the event via a common carrier.

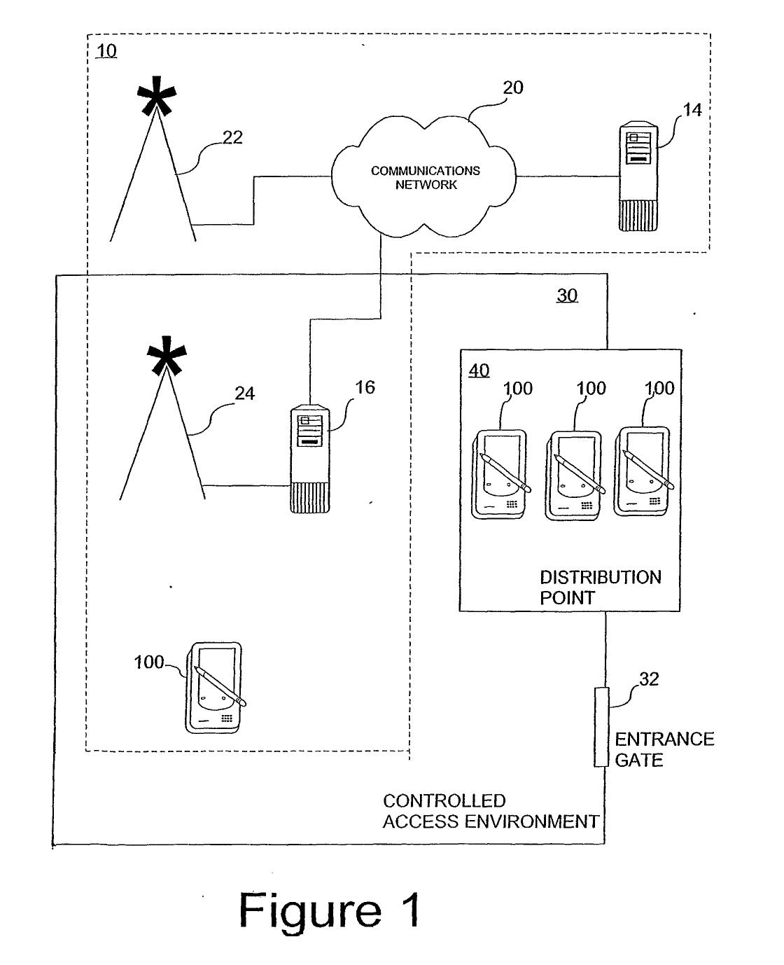

The information dissemination method of the present invention may be understood with reference to the simplified network environment (system) 10 and controlled access environment 30 of FIG. 1. The controlled access environment 30 may include any defined area in which access is controlled and/or limited, as is generally well known in pay-for-admittance events. For example, in the context of a professional golf tournament, the controlled access environment 30 may include a fence-enclosed golf course having a single entrance/egress gate 32 controlled by an authority that hosts, organizes, coordinates, or officiates an event held within the environment 30. Ticket takers may be present at the gate and deny admittance to any person who does not have a ticket. In addition, as is known for professional golf events sponsored and/or hosted by the PGA, access is controlled in that any person having a wireless communication device is prohibited from carrying such device into the controlled access area. Typically, individuals are required to “check” any such devices at the gate and reclaim such devices when exiting the controlled access environment 30.

As shown in FIG. 1, a server 14 of the network environment 10 can communicate with one or more client devices 100 via a communications network 20 and broadcast antenna 22. By way of example, the communications network 20 could be a local area network (LAN), wide area network (WAN), an intranet, the Internet, etc. Any network configuration allowing data to flow between points of access may be used. In this example, the communications network 20 is the Internet, and server 14 is an HTTP Web server. Accordingly, server 14 may be located virtually anywhere, and need not be located within the controlled access environment 30.

Alternatively, a server 16 located within the controlled access environment 30 may be used to serve information content for distribution to the devices 100 via a broadcast antenna 24 within the controlled access environment 30, or via an external network 20 via an external antenna 22, as shown in FIG. 1. Optionally, a portion of the information content, signals, etc. broadcast by antenna 22, 24 is available to devices outside the environment 30, either to standard wireless devices or only to specially configured devices 100. Alternatively, information content, signals, etc. broadcast to the devices 100 are receivable only by such devices 100. By way of example, this may be achieved using encryption, password protected subscriber accounts, firewall protected access, cellular communications, short range wireless communications techniques, or any of a variety of techniques well known in the art.

In a preferred embodiment, server 14/server 16 are application server running JBOSS 3.2.3 on a Microsoft Windows XP Professional operating system, and including a PowerGres or PostGres SQL database, Jakarta Struts (to allow standard HTTP access), and a servlet for receiving HTTP GET requests and for providing XML-formatted data in response to such requests.

Accordingly, the server 14, 16 and client devices 100 can communicate with each other via a common protocol, such as the hypertext transfer protocol (HTTP) and/or various wireless communications protocols well known in the art. Any conventional Web and/or wireless communication technologies may be used. It will be understood by those skilled in the art that an actual network topology may include numerous client devices, servers, etc. The client device 100 may interface with the communications network 20 via web browser software stored and/or running on the client device 100. Currently, various alternative browser software applications are commercially available for personal computers and other web-enabled devices, such as a mobile telephone, Internet appliance, personal digital assistant (PDA), etc. The client device 100 includes a graphical user interface allowing a user to send and receive data to and from the server 14/16, as generally known in the art for network communication in a Web environment. Hardware of the device 100 includes hardware of a conventional type known for Web-enabled and/or wireless devices, and is capable of receiving and interpreting signals broadcast by wireless transmission and displaying information content represented by such signals to a user via the client device 100. For example, client device 100 may be implemented using a general-purpose wireless communications device, such as an i705 PDA manufactured and/or distributed by Palm, Inc. of Malpitas, Calif;., U.S.A., or preferably an iPAQ 2210/2215 or 2410 with a Intel x400 CPU, 64 Meg memory, 3.5″ color LCD screen with 240×320 resolution, 5 way navigation buttons for one-handed use, battery life of 3.5-4.5 hours continuous use, and Internet connectivity via either 802.11b/g WiFi or CDMA wireless modem, as manufactured and/or distributed by Hewlett-Packard Company of Palo Alto, Calif., U.S.A.

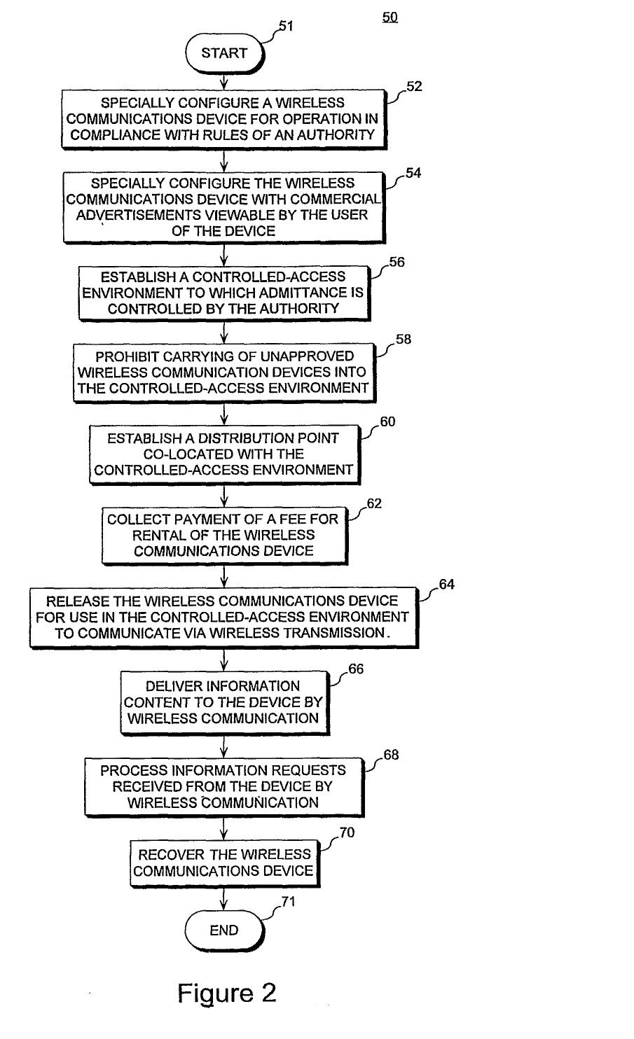

Referring now to FIG. 2, a flow diagram 50 is shown that illustrates an exemplary method in accordance with the present invention. In the example of FIG. 2, the method begins with specially configuring a wireless communication device for operation in compliance with rules of an authority controlling a controlled access environment, as shown at steps 51 and 52. This may involve installing specialized software on a general-purpose wireless communications device, e.g., as identified above. Alternatively, this may involve manufacturing a PDA or similar wireless communications device to include certain hardware and/or software to provide the desired functionality. The functionality to be provided may be determined by the authority. For example, the PGA is an authority that hosts, sponsors, or otherwise controls PGA professional golf tournaments. Accordingly, the PGA may have certain rules that the specially configured devices may be configured to comply with. For example, the PGA may have a rule requiring that no ring tones, beeps, chirps or other sounds issue from such specially configured devices. A common vibration feature of such devices could also be avoided. Accordingly, such functionality common to many such devices may be disabled in the specially configured devices. Additionally, the PGA may wish such devices to offer GPS-driven functionality, such as the Find-A-Friend feature discussed below, and/or to offer certain “hot” buttons hard wired to provide certain functionality, such as a “Roar” button that may be depressed to initiate transfer of information to the device 100 at the user's initiative, as discussed further below.

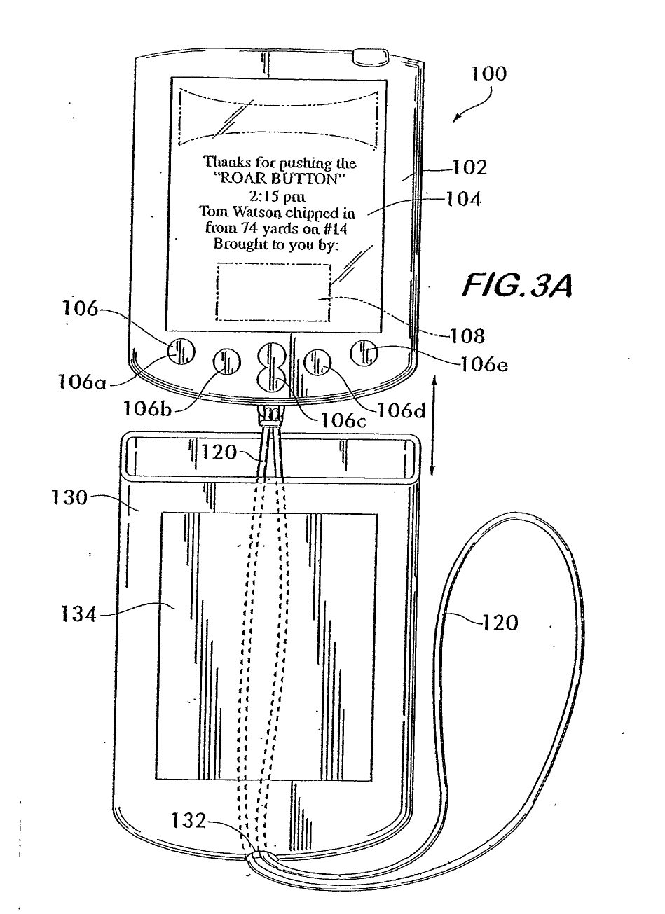

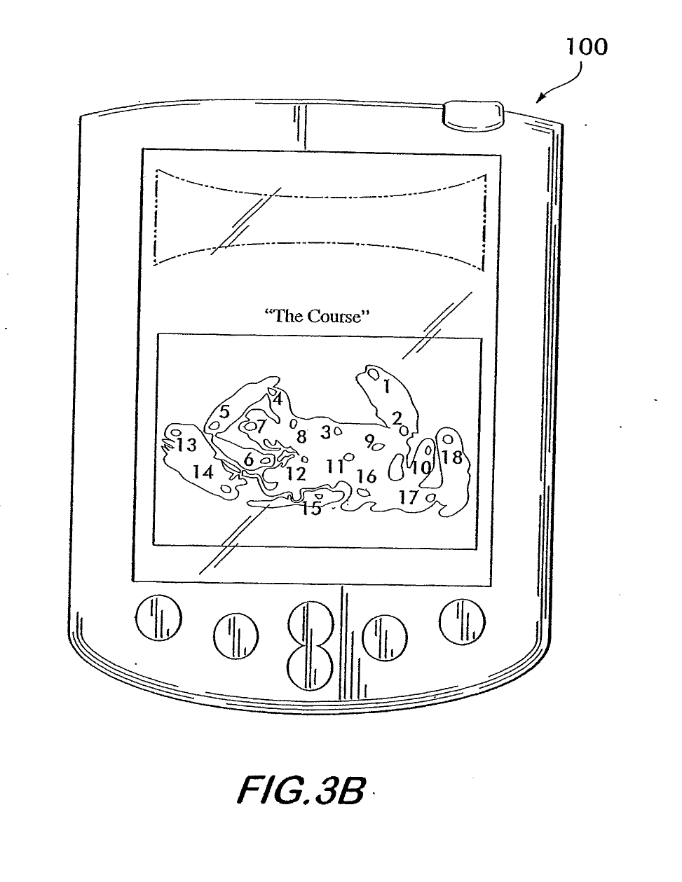

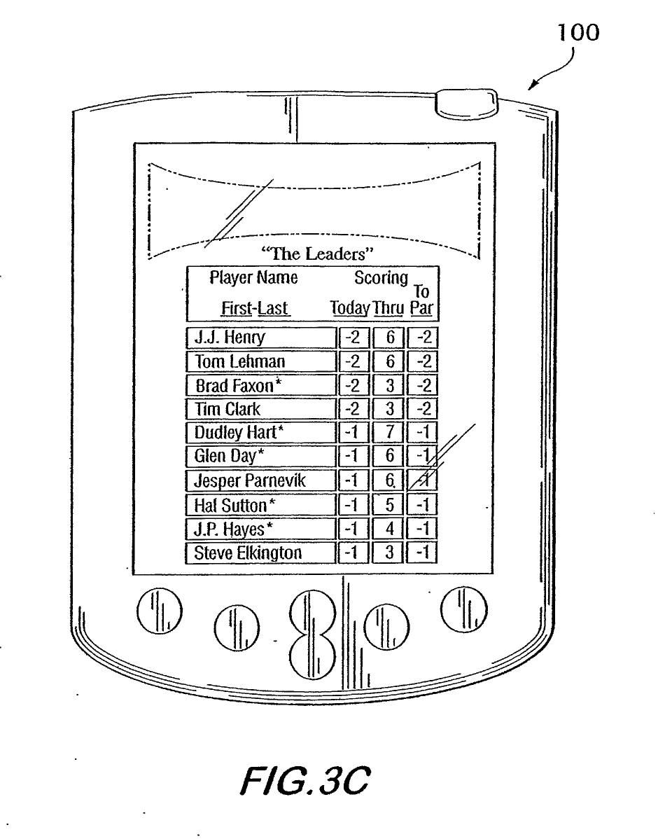

The wireless communications device 100 (FIGS. 1 and 3) may also be specially configured with commercial advertisements viewable by the user of the device, as shown at step 54 of FIG. 2. In this manner, the device itself acts as an advertising medium. Accordingly, distribution of the device may be used to generate a revenue stream by selling advertising space on the devices to commercial entities, etc.

As shown in the exemplary device of FIG. 3A, the device 100 includes a housing 102, a display screen 104 and function/navigation buttons 1 06a, 1 06b, 1 06c, 1 06d, 1 06e, as known in the art for PDA and similar devices. Configuring the device 100 with commercial advertisements may occur in various ways. For example, configuring the device 100 may include providing a label, printing, etc. directly on the housing 102 of the device. Alternatively, such configuring may include providing the device 100 with software for displaying an advertisement (e.g. 108) via the display screen 104. Such configuring may include providing the device 100 with software for completing a sales transaction for merchandise.

In some embodiments (see FIG. 3A), the device 100 includes a lanyard 120 for hanging the device 100 from a spectator's neck. In such an embodiment, the lanyard itself may be printed, embroidered, etc. to display advertising indicia. Additionally, the exemplary device includes a cover 130 for protecting the electronics of the device 100 from rain, spilled drinks, etc. The cover 130 may be provided as a pocket or sleeve dimensioned to fit over the housing 102. In such an embodiment, the cover 130 may include an opening 132 allowing the lanyard 120 to pass therethrough, thereby allowing sliding of the cover 130 relative to the lanyard 120 as the device 100 is worn around the neck, to cover or uncover the housing 102. In embodiments including a cover 130, the cover may also be used as an advertising medium for bearing an advertisement (e.g. 134) on its front or rear side. In other embodiments, the device 100 includes, e.g. on its rear side, a conventional belt clip of a type used for pagers, wireless telephones, etc. to facilitate attachment of the device to a wearer's belt. Optionally, the device may be attached to the belt clip by a tether of a length sufficient to allow the user to view the device's display screen while preventing the device from hitting the group if dropped while the clip is attached to the belt.

Referring again to FIG. 2, the method continues with establishment of a controlled-access environment to which admittance is controlled by the authority, e.g. a pay-for-admittance golf tournament event held on golf course grounds, as shown at step 56. Optionally, the authority may impose a rule that prohibits carrying of unapproved wireless communication devices into the controlled access environment 30, as shown at step 58. This is typical of PGA and tour golf tournaments, as discussed above.

Next, a distribution point 40 co-located with the controlled access environment 30 (see FIG. 1) is established, as shown at step 60. As used herein, “co-located” is used broadly, to include a position within the controlled access environment, outside the environment but on the premises of a facility for the controlled access environment (e.g. on the grounds of the golf course), nearby the environment, e.g. within one mile of a boundary of the controlled access environment, or in another location servicing persons entering the controlled access environment. By way of example, the distribution point may be a tent, booth, kiosk, or other designated area where devices may be borrowed and/or returned. In FIG. 1, the co-located distribution point 40 is shown in block form to straddle the boundary of the controlled access environment 30.

The method further includes collecting payment of a fee for rental of the device 100, as shown at step 62. This may include collection of a rental fee in cash, or by credit card payment. Alternatively, this may include collection of a security deposit to ensure against theft of the device, and subsequent refunding of a portion of the security deposit, the remainder being retained as a rental fee. Fees may also be collected for rental insurance in the event of lost or damages devices, etc. Any suitable method for collection of a fee may be used.

A device 100 is next released from the distribution point 40 for use in the controlled access environment 30, as shown at step 64. In other words, a device 100 is lent to an attendee that has paid the rental fee/security deposit. The user of the device is then free to wander about the controlled access environment 30 and use the device 100 to receive information content or otherwise communicate by wireless transmission.

The method may include delivering information content to the device 100 by wireless communication, as shown at step 66. Preferably, the information content delivered to the device relates specifically to the controlled access environment and/or an event being conducted in the controlled access environment at the time of delivery of the information content. This may include transmission of data from servers 14 and/or 16 via antennas 22 and/or 24 of FIG. 1. Accordingly, this allows for dissemination of information that might not otherwise be relevant to a viewer/user that receives data via a Web interface that is not specifically related to a controlled access environment. For example, the information content delivered to the device while the device is operated within the controlled access environment may include a map indicating location of restrooms. Such information is not particularly relevant for delivery by a Web interface to members of the general public that may never attend the event. Additionally, it allows for time-sensitive delivery of information relating to events occurring within the controlled access environment. For example, the information content may include an announcement that the next 50 visitors to the golf course's clubhouse will receive a free gift, or that there is presently no line at a certain concession stand, or that a certain event is about to happen, e.g. Tiger Woods is approaching the tee of the fourth hole during a golf tournament. These types of announcements allow the individual to react to the announcement in real time, and can be used to control foot traffic, divert individuals to smooth loads on restrooms, concession stands, etc. By way of further example, information content delivered via the device 100 may include a weather report including current temperature, sun factor, inclement weather warnings, wind speed, etc. By way of further example, in the context of a controlled access environment that is a golf course hosting a golf tournament, the information content may include a traffic/parking/concession/restroom map, a golf course layout (see FIG. 3B), golf course history, hole description, past event trivia, golf trivia, pertinent rules of golf, stimpmeter results providing a measurement of greens speed, player biographies, transportation information identifying bus routes, schedules or other transportation means from the environment to a remove parking area, etc. Optionally, some of this information may be stored in a memory of the device, e.g. by loading such information onto the device 100 at the distribution point 40, without the need to broadcast such information to the device. The information content may further include broadcasted data updated in real-time, such as a leaderboard (see FIG. 3C) showing player scores, player ranking, player progress reports, and player location reports to indicate who is playing a certain hole, who is approaching a certain hole, etc.

Additionally, the method may include processing of information requests (e.g. data) received from the device 100 by wireless communication, as shown at step 68. Accordingly, the device 100 may be interactive, and provide a unique experience to each device user as a function of the user's information requests. Such information may be provided in addition to any information content broadcasted to multiple devices absent a user's information request. For example, a certain feature of the present device is a Roar Announcement function. In an embodiment of the device including such functionality, a Roar Announcement command may be executed by a user by pressing a designated button of the device, e.g. 106(e), and/or selecting an appropriate icon or menu option displayed via the device's display screen 104. When a user hears the roar of the crowd, e.g. coming from an adjacent hole of a golf course, and the user cannot see what has just transpired, the user may execute the Roar Announcement command. Execution of such a command transmits a signal from the device 100 via wireless transmission that is a request for information content explaining what has just happened within the controlled access environment that incited the crowd to roar. This causes the server 14, 16 to transmit via wireless transmission information content describing what has just transpired, e.g. a certain player making a certain shot. See information content displayed via screen 104 of device 100 in FIG. 3. Alternatively, information content explaining the roar of a crowd may be automatically “pushed” to a device 100 from the server 14, 16 without the need for execution of a command at the device 100 to initiate a request. By way of example, in the context of a golf tournament, volunteers arranged about the golf course may track various aspects of a golf drive, chip, putt, etc. as to distance, location, stance, lie, etc., and enter such information and/or descriptive text into a handheld device that causes data to be transmitted to a centralized computing facility for inclusion in a central scoring administration system. This information may be used to create the information content transmitted to the device 100 in response to execution of the Roar Announcement command. The Tour uses a ShotLink system to permit volunteers to gather and transmit such information, and compiles a database of information referred to as Tournament Tracker. The dissemination of information via TOURCast is an application utilizing such database. Accordingly, the device 100 may be used to receive and/or send information to provide a range of functionality, as discussed further below.

Additional functionality may be provided when the device is configured with suitable hardware and/or software for providing GPS capability. Such GPS capability is well known in the art for providing a physical location of a device. When the device 100 is configured so that it can determine where it is presently located, e.g. at a certain longitudinal and latitudinal position with respect to the earth, additional information can be provided as a function of such location information. For example, a best evacuation route may be provided in the event of an emergency, such as a thunderstorm on a golf course. Additionally, a medical alert may be issued to indicate to a central monitoring station that medical assistance is needed at a geographic location of the device 100 when a medical alert command is activated on the device. For example, this command may be initiated by pressing a designated button of the device 100. Such features are not relevant when such information devices are viewable globally, outside of the controlled access environment.

Additional features are provided via the device that are not relevant when information content is viewable globally, outside of the controlled access environment. For example, the device may provide Find-A-Friend functionality when more than one device is GPS capable. This facilitates rejoinder of spectators that become separated, which is common for spectators of golf tournaments because of the concurrent occurrence of play at multiple locations. For example, pressing of a designated button or otherwise initiating this functionality may cause information to be transmitted to the device 100 that indicates a location of another device 100. For example, each individual device may be assigned a code, and that code may be input by a user to the device 100, which then communicates with a central system to find another device having the designated code. For example, such information may be communicated by showing the position of the other individual's device on a map of the controlled access environment, e.g. with a symbol. Alternatively, two or more devices may be associated with one another by an attendant of the distribution point, such that initiating the Find-A-Friend feature on one device will automatically return the position of the associated device. Additionally, the device 100 may allow for messaging between devices of the system, e.g. so that one person within the environment 30 may send a message to another person within the environment 30 via the devices 100, e.g. to say “meet me at the 18^{th} green in ten minutes.” Optionally, a menu driven graphical user interface may be provided that will permit a user to select from a pre-established list of messages or portions of messages. For devices including GPS capability, the device may provide directions for a best route to reach the designated meeting place (e.g. 18^{th} green) from the current location of the device when this feature is used. This may be accomplished in a variety of ways, as will be appreciated by those skilled in the art. Software for performing this functionality is preferably stored on the device.

Finally, the method ends with recovering the device 100 from the borrower, e.g. at the distribution point 40, as shown at steps 70 and 71. Optionally, a portion of any security deposit may be refunded and/or payment for the device may be perfected at this time. For example, the user may return the device 100 to the distribution point 40 as the user exits the controlled access environment 30 via the gate 32.

It should be noted that corporate sponsors may wish to rent or otherwise arrange to have a number of such devices available for use by their guests, e.g. without a rental charge to the guest. For example, rental of such devices may be included as part of a bundle of services provided in connection with the corporate sponsor's purchase/rental of a hospitality tent at the event. Alternatively, the corporate sponsor may pay separate rental fees for use of such devices. When a corporate sponsor intends to offer such devices to its guests, additional provisions may be made to identify such devices separately from other devices usable within the controlled access environment, such that the sponsor or another can send information content to those devices provided to its guests, without providing such information content to other devices operating within the same system. For example, such information content may be used to recall such guests to a corporate hospitality tent for a certain event or function to be held in the tent.

Accordingly, a person entering a controlled-access environment may rent a specially configured device at the controlled-access environment, use the device within the controlled-access environment, and then return the device. The rental of such devices provides additional revenues to the authority controlling access to the environment. Use of the device by persons entering the environment can be enhanced by imposing a rule prohibiting persons entering the environment from carrying their own, unapproved, wireless communication devices into the environment. Additionally, the authority maintains control over use of the devices by having them specially configured to meet the authority's needs/desires/rules, e.g. to prevent noise from such devices. Further, the device itself may be used as an advertising medium by configuring the devices to display advertisements/advertising indicia. For example, such advertising space may be sold/leased to commercial entities, which further enhances the authority's revenues.

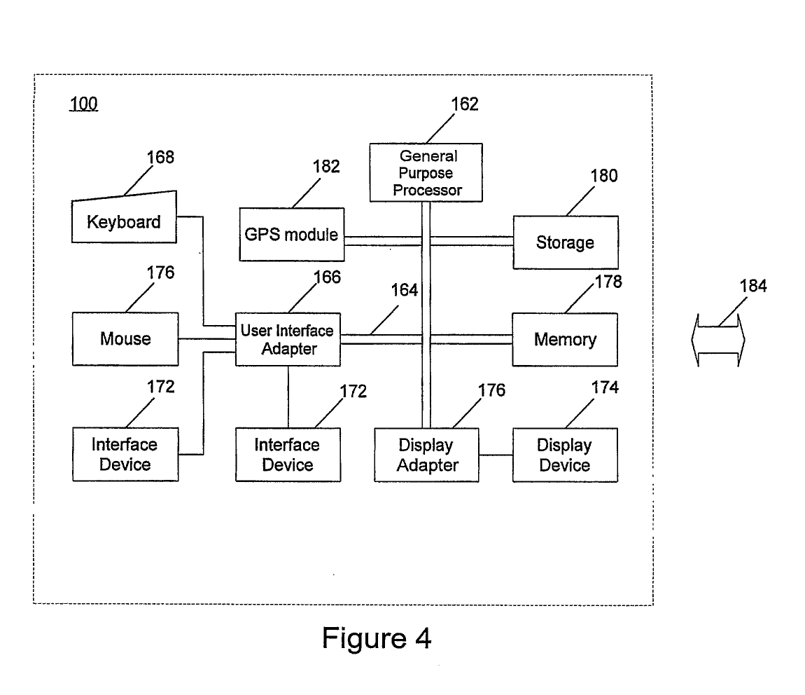

FIG. 4 is a block diagram of a wireless communications device 100 (see FIGS. 1 and 3) in accordance with the present invention. The device 100 may include hardware and software similar to that employed for conventional wireless communication devices, such as personal digital assistant (PDA) devices. As is well known in the art, the device of FIG. 4 includes a general purpose microprocessor (CPU) 162 and a bus 164 employed to connect and enable communication between the microprocessor 162 and the components of the device 100 in accordance with known techniques. The device 100 typically includes a user interface adapter 166, which connects the microprocessor 162 via the bus 164 to one or more interface devices, such as a keyboard 168, mouse 170, and/or other interface devices 172, which can be any user interface device, such as a touch sensitive screen, digitized entry pad, etc. The bus 164 also connects a display device 174, such as an LCD screen or monitor, to the microprocessor 162 via a display adapter 176. The bus 164 also connects the microprocessor 162 to memory 178 and long-term storage 180 (collectively, “memory”) which can include a hard drive, diskette drive, tape drive, etc. The bus 164 further connects the microprocessor 162 to a global positioning system (GPS) module 182, which may include hardware and software of a type generally known in the art for determining a geographic position of the device 100.

The device 100 may communicate with other computers or networks of computers, for example via a communications channel, wireless network card/antenna or wireless modem/antenna 182. The device 100 may be associated with such other computers in a local area network (LAN), a wide area network (WAN), intranet, Internet, etc. such that it may communicate by wireless communication. All of these configurations, as well as the appropriate communications hardware and software, are known in the art.

Software programming code for carrying out the inventive method is typically stored in the memory 178,180 of the device 100. Accordingly, the device 100 stores in its memory microprocessor executable instructions. Additionally, computer-readable media storing computer-readable code for implementing the method steps may be provided (see discussion of method steps above).

In a preferred embodiment, the invention further includes a method for receiving, storing and updating internet content on the device 100. The method includes receiving externally-stored internet content via a wireless internet connection, converting references to externally-stored internet content to references to locally-stored content, and storing the converted internet content as locally-stored content. The method may further include monitoring the externally-stored internet content for updates, and updating the locally-stored internet content accordingly.

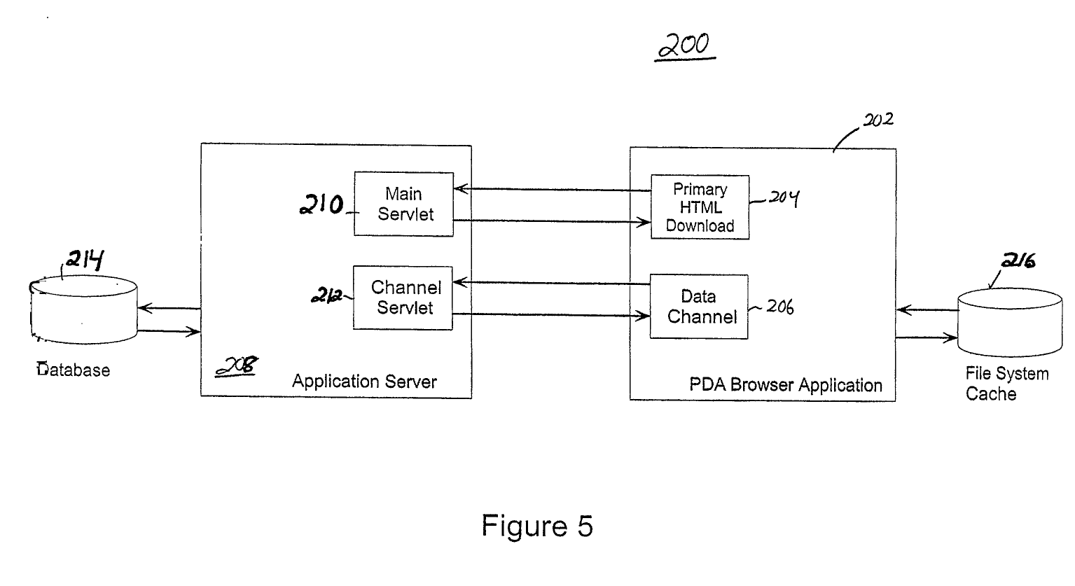

These steps may be implemented as a custom browser application 210, shown in FIG. 5. Custom browser 210 may be developed using Microsoft's Embedded Visual C++ 4.0 IDE (integrated development environment), Microsoft Pocket PC 2003 SDK (software development kit), and Microsoft Windows CE 4.2 software libraries. It may be written in C++ or in any object-oriented programming language that provides equivalent functionality to that described below. Further, it preferably makes use of COM (Component Object Model) interfaces (native to the Pocket PC 2003 environment).

Customized browser application 202 preferably includes a primary HTML page retrieval and conversion module 204, responsible for downloading Internet-accessible content from server 14 or server 16 (represented in FIG. 5 as application server 208), converting the retrieved content (HTML pages, images and style sheets) to run locally, and saving the modified files to the PDA's file system. Customized browser application 202 preferably further includes a data channel module 206 capable of sending requests to a servlet (channel servlet 212) on application server 208, retrieving requested content in XML format, parsing the XML content, and updating the content displayed on the PDA or stored in a file system cache 216. Customized browser 202 preferably also provides a means for receiving and displaying information of importance to the user.

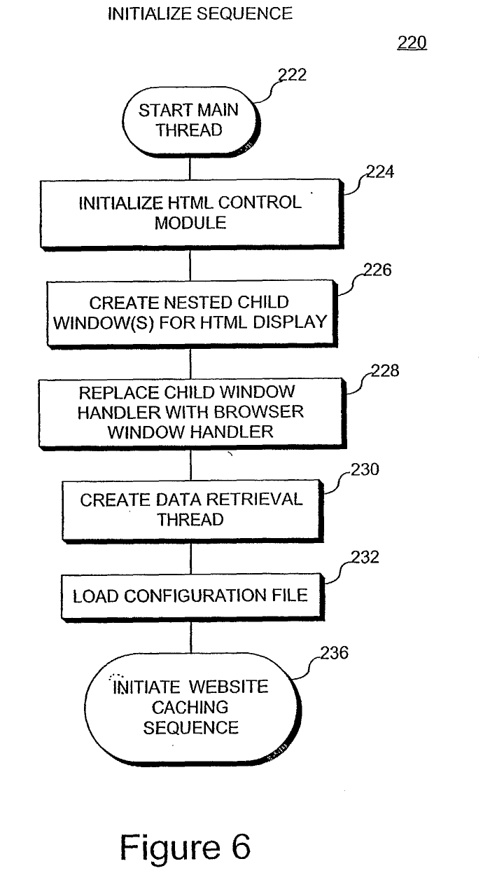

FIG. 6 depicts a preferred sequence for initializing customized browser 202. When browser 202 starts, it first creates a main window 222. The operating system sends a WM_CREATE message to browser 202 after creating the window. Browser 202 posts a message to the window that then leads (in step 224) to the creation of the HTML Control, using the Pocket PC SDK call, InitHTMLControl. In step 226, two nested child windows are generated that host the HTML display. In step 228, the known technique of procedure chaining is then used to replace the window handler with the window handler component of browser 202. In this way, keyboard and other inputs can be handled directly by browser 202, rather than by the window handler of the operating system on device 100.

Optionally, a C++ class, CMylbApp may be used to restrict access to global variables and methods. The InitInterfaces method of this class is then called. Two additional structures are created next. In step 230, a data retrieval thread 230 (identified in FIG. 5 as primary HTML page retrieval and conversion module 204) is created. This thread is preferably responsible for all of the data channel access and processing. In addition, an edit window (not shown) may be created as a child window of the HTML Control for displaying the alert information.

Preferably, certain system calls (e.g., GXOpenDisplay and GXOpenInput) may be made to block out other applications and to take the full screen for display.

In step 232, a configuration file for browser 202 is loaded. Preferably, the configuration file is stored locally on the PDA and determines the URL of application server 208. The URL defines the protocol (http), the server name, and the port number, for example: http://www.myserver.com:8080. A “splash.htm” file that is stored locally on the PDA may also be displayed during the startup process.

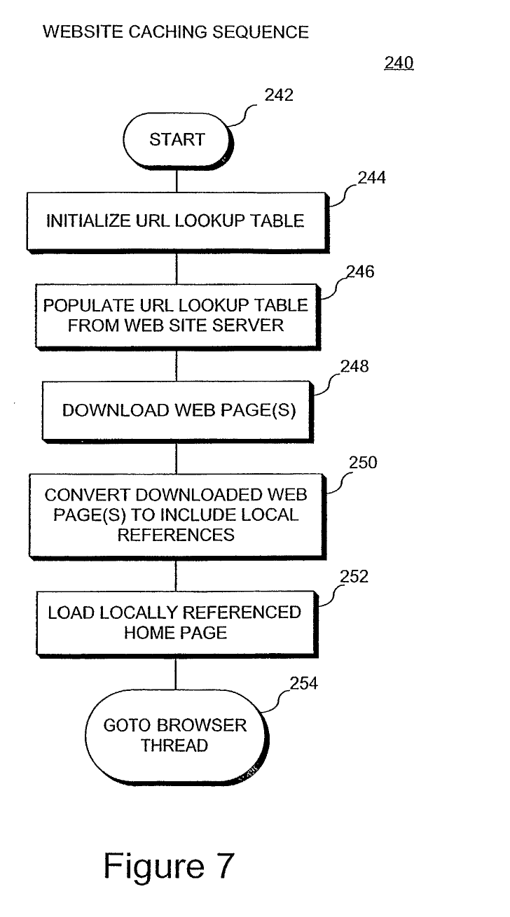

In step 236, browser 202 initiates a website caching sequence in order to download internet content stored on application server 208. This website caching sequence is depicted in FIG. 7.

With reference to FIG. 7, in step 244 browser 202 creates and initializes a URL lookup table on device 100. This table may have the following data structure:

| typedef struct { | |
|---|---|
| char | source[50]; |
| char | local[50]; |
| BOOL | bBinary; |
| BOOL | bGetFresh; |
| int | channelType; |
| char | channelString[100]; |
| BOOL | bPaged; |
| int | pageNumber; |
| int | numParams; |
| char | params[4][10]; |

} URLLookup;

This table is used to track each item of content that is downloaded from application server 208 and stored in file system cache 216. Each item in file system cache 216 has a corresponding entry in the array of URLLookup's.

During the website caching sequence, the base website address that is assumed for the server URL's is the URL retrieved from the config file. Using this base website address, browser 202 contacts application server 208 and populates the URL Lookup Table based on the various files that are located at the base website address on application server 208. Such files may include HTML, XML, image and/or other support files, such as cascading style sheets (.css files). Each file is added as an entry in the URLLookup table.

Further, as reflected in the C++ source code above, the URL Lookup table includes a “source” field that contains each Internet-accessible item stored on application server 208, and a “local” field that contains the name of the corresponding item to be locally stored on device 100. An example would be the home page, which has a source name of “” and a local name of “index.htm”. When the source name is concatenated to the server address, it becomes http://www.myserver.com:8080, which is interpreted by the server to be a reference to the internet content “/WelcomeAction.do” and results in server processing (as dictated by “WelcomeAction.do”) before generating an HTML page.

After the URL Lookup Table is initially populated, in step 248 browser 202 downloads the website content stored at the base address. The C++ function, URLDownloadToFile, may be used for this purpose.

In step 250, browser 202 converts any references in the downloaded website content to externally-located content, such as the website image files originally located on application server 208, into references to the downloaded version of the website that is now stored in cache 216. Thus, browser 202 parses each file that is downloaded, modifying each referenced URL to be locally accessible. The base address that may be used for the local, cached, files is of the form: file://\directory\file.htm.

By way of example, if there were a picture of a golf hole on a web page, “hole1.htm”, that picture could not be referenced (in device 100) as http://www.myserver.com:8080/myapp/images/hole1pict.gif, because that reference would require connectivity to access, despite the fact that the file was already sitting in the cache 216. Rather, in step 250, the above URL would be modified to refer to file://\directory\images\hole1pict.gif in the local cache file.

The URL Lookup table further includes a “numParams” field. This field is is important, because it allows browser 202 to determine whether the page is simply loaded as is, or whether additional parameters must be added to the URL and the same URL repeatedly downloaded. In the golf tournament described above, it may be desired to display information for each hole of the golf course, one on each page. If device 100 was always connected to the application server 208, one could use a URL such as http://www.myserver.com:8080/HoleInfo.do?hole=1 to get the first hole's page. That parameter is processed by the application server 208 to retrieve the particular hole's information. However, to generate a complete locally-viewable copy of the desired website, with all its pages available at device 100 when device 100 is “off-line”, the files in cache 216 must contain a “built” HTML page for each hole. In this example, thus, these entries would be expanded in the URLLookup table to contain a row for each hole, as: source=HoleInfo.do?hole=1, local=hole1.htm, HoleInfo.do?hole=2, local=hole2.htm, etc.

As an option, the bBinary flag of the URLLookup structure may be used as a Boolean variable used to turn off the parsing in step 250 and replacing of URL's for a given type of referenced file, such as an image file, since there is no reason to parse an image file for URL's and doing so may corrupt the file.

Additional parameters may be added to the URL Lookup Table, and used in the reference conversion process, based on the particular public event. In the example of the golf course, two parameters may be automatically added to each source URL—the geid (golf event id) and gcid (golf course id). These database identifiers may be retrieved along with the initial URLLookup data in the startup sequence. Another option in the startup sequence may be to add requests for parameter lists. In the golf tournament example, it is known that there will be 18 holes on a golf course, but how many players will be playing in the event? If each player has a web page, then that information may be conveyed during the start-up sequence, so appropriate entries may be made in the URLLookup table. For example, a player bio page could have source URL of http://www.myserver.com:8080/myapp/PlayerBio.do?playerID=123, which would be converted to a local reference to the “bio123.htm” file stored in cache 216, but the list of player id's (a number associated with each player) needs to be in hand to process this information.

The website page content, which may be in XML format, may be quite extensive. A sample URL for the startup channel is: http://www.myserver.com:8080/myapp/GolfPDAChannelServlet?cmd=GetGolfStartupInfo&n pl=true, where npl is a flag to return the player list. The returned XML may be of the form:

<ggsi><geid>1</geid><gcid>1</gcid>
<vgep source=”PlayerBio.do”
local=”bio.htm” binary=”false” numParams=”1” param=”pid”/>
<vgep source=”HoleInfo.do”
local=”hole.htm” binary=”false”
numParams=”1” param=”hole”/> <vgep source=”Trivia.do”
local=”triv.htm” binary=”false” numParams=”0” />
... more page entries ...
<vgepi pid=”1” name=”Bobby Jones” city=”Barnstable” state=”MA”/>
... more player entries ...
</ggsi>

A comparative example of a source file, http://www.myserver.com:8080/HoleInfo.do?hole=1, downloaded, converted, and stored in a locally-accessible file, “\mlb\hole1.htm.temp” is as follows:

### Original Form of Content on Application Server 208:

```
<html>
<head>
<title>Leaderboard</title>
      <link rel=“stylesheet” type=“text/css” href=“styles/pda.css”>
</head>
<body>
<table width=“220” border=“1” bordercolor=“#FFFFFF”
bgcolor=“#006600”>
  <tr>
    <td width=“226” valign=“top”>
      <table width=“220” height=“24” border=“0”>
      <tr bordercolor=“#FFFFFF” bgcolor=“#006600”>
        <td valign=“top” class=“head”>Merion Golf Club
        East Course</td>
      </tr>
    </table>
    <table width=“220” border=“1” cellspacing=“0”>
      <tr>
        <td class=“norm”>Course Layout Hole One</td>
      </tr>
      <tr>
        <td class=“tiny”>Dan Jenkins called it the
        &quot;best opening hole in golf&quot;.
  So long you can&#39;t hit it. So short you can&#39;t see it.
</td>
      </tr>
      <tr>
        <td class=“head”>Par 4, Length 362, Stroke 9</td>
      </tr>
      <tr>
        <td valign=“top” bgcolor=“#006600”>
          <img src=‘images/merion_east_hole_1.gif’ width=“220”>
        </td>
      </tr>
    </table>
    <table width=“220” border=“1” cellspacing=“0”>
      <tr>
        <td class=“norm”><a href=“/mylb-golf-pdaclient/
CourseLayout.do”>Back to Course Layout</a></td>
      </tr>
    </table>
    </td>
  </tr>
</table>
</body>
</html>
```

### Converted Form of Content Suitable for Storage in Cache 216:

```
<html>
<head>
<title>Leaderboard</title>
      <link rel=“stylesheet” type=“text/css” href=“\mlb\styles\pda.css”>
</head>
<body>
<table width=“220” border=“1” bordercolor=“#FFFFFF”
bgcolor=“#006600”>
  <tr>
    <td width=“226” valign=“top”>
      <table width=“220” height=“24” border=“0”>
      <tr bordercolor=“#FFFFFF” bgcolor=“#006600”>
        <td valign=“top” class=“head”>Merion Golf Club
        East Course</td>
      </tr>
    </table>
    <table width=“220” border=“1” cellspacing=“0”>
      <tr>
        <td class=“norm”>Course Layout Hole One</td>
      </tr>
      <tr>
      <td class=“tiny”>Dan Jenkins called it the &quot;best opening
      hole in golf&quot;.
  So long you can&#39;t hit it. So short you can&#39;t see it.
</td>
      </tr>
      <tr>
        <td class=“head”>Par 4, Length 362, Stroke 9</td>
      </tr>
      <tr>
        <td valign=“top” bgcolor=“#006600”>
          <img src=‘\mlb\images\merion_east_hole_1.gif’
          width=“220”>
        </td>
      </tr>
    </table>
    <table width=“220” border=“1” cellspacing=“0”>
      <tr>
        <td class=“norm”><a href=“\mlb\crs.htm”>Back to Course
        Layout</a></td>
      </tr>
    </table>
    </td>
  </tr>
</table>
</body>
</html>
```

It may be seen from this example that that all of the external references were modified to a local form, including style sheets (styles/pda.css becomes \mlb\styles\pda.css), images (images/merion_east_hole_{—}1_.gif becomes \mlb\images\merion_east_hole_{—}1.gif), and the links are also modified, according to the URLLookup table entry (/mylb-golf-pdaclient/CourseLayout.do becomes \mlb\crs.htm).

One of ordinary skill in the art will appreciate that two Component Object Module (COM) objects may be used to download and parse the website data: XMLHTTP and XMLDOM. These operating system-supplied objects are quite useful in requesting and downloading XML data, and then parsing that data so that it can be transferred to a destination file or a data structure. An example of C++ source code that may be used to access these two COM objects is as follows:

```
IXMLDOMDocument *pXMLDoc;
IXMLHTTPRequest *pXMLHttp;
char buff[200];
HRESULT hr;
VARIANT vt_false = { VT_BOOL, 0, 0, 0, VARIANT_FALSE };
VARIANT vt_true = { VT_BOOL, 0, 0, 0, VARIANT_TRUE };
VARIANT vt_empty = { VT_EMPTY };
VARIANT vt_string = { VT_BSTR };
hr = CoCreateInstance (CLSID_XMLHTTPRequest, NULL,
CLSCTX_INPROC_SERVER,
    IID_IXMLHTTPRequest, (void**)&pXMLHttp);
hr = CoCreateInstance (CLSID_DOMDocument, NULL,
CLSCTX_INPROC_SERVER,
  IID_IXMLDOMDocument, (void**)&pXMLDoc);
vt_string.bstrVal = L“”;
strcpy (buff, m_pBaseUrl);
strcat (buff,
“GolfPDAChannelServlet?cmd=GetGolfStartupInfo&npl=true”);
mbstowcs (scratchBuff, buff, 400);
BSTR urlBstr = SysAllocString (scratchBuff);
hr = pXMLHttp->open(L“GET”, urlBstr, vt_true, vt_string, vt_string);
hr = pXMLHttp->setRequestHeader (L“Content-Type”, L“text/html”);
VARIANT vt_body;
vt_body.vt = VT_BSTR;
vt_body.bstrVal = L“<html></html>”;
hr = pXMLHttp->send (vt_body);
if (WaitForResponse (pXMLHttp)) {
    {
        BSTR bstrResponse;
        hr = pXMLHttp->get_responseText ((BSTR *)&bstrResponse);
        VARIANT_BOOL vt_return;
        hr = pXMLDoc->loadXML (bstrResponse, &vt_return);
        SysFreeString (bstrResponse);
    }
}
SysFreeString (urlBstr);
pXMLDoc->Release ( );
pXMLHttp->Release ( );
```

The final step in the web caching sequence, depicted in step 252, is to instruct the HTML Control to display the locally-cached version of the home page. This loads the locally-referenced home page, which is then displayed to the user.

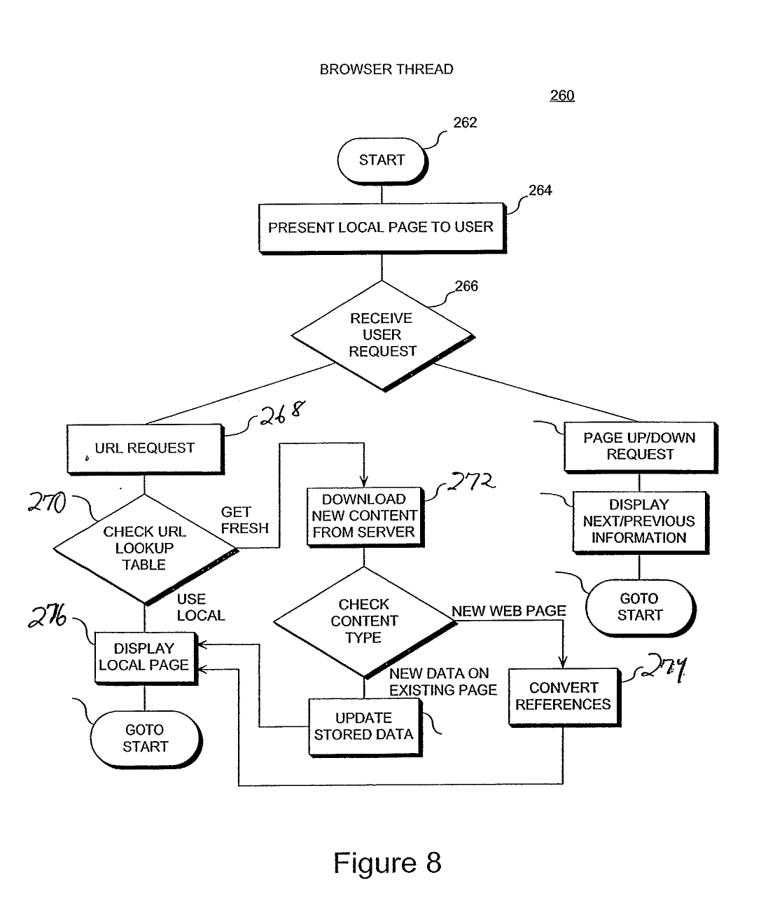

With reference to FIG. 8, in step 264 the home page is loaded and shown to the user. The user can navigate through the entire, cached web site via the browser thread by selecting links presented by the browser, or by pressing specific, dedicated buttons on device 100. Preferably, the browser thread is event-driven, e.g., by means of HTML Control notification messages sent from the HTML Control when particular events occur. Examples of events that may be included in the browser thread include:
NM_BEFORENAVIGATE—Notifies the browser thread application that a URL has been requested (as in step 268)—Look up the requested URL in the URLLookup table (step 270). If the entry has a flag to “get fresh”, then use the same mechanism from the startup sequence to download and convert the file (steps 272, 274) before the local copy is navigated to (step 276). If the download fails, the locally cached copy is navigated to.
NM_DOCUMENTCOMPLETE—Notifies the browser thread that the URL has loaded—Look up the requested URL in the URLLookup table. Delete the IPIEHTMLDocument2 pointer to the cached version of the now-outdated locally-stored content and get the new one to the newly cached version of the locally-stored content. Deleting and assigning a new IPIEHTMLDocument2 pointer must be protected by “critical” section semaphores to prevent the use of the pointer from overlapping this process.
NM_HOTSPOT—notifies the browser thread that the user has selected a pre-established navigation button (e.g., page up/down; goto home; goto product information or help page; etc.)—Look up the requested URL, to see if the entry has multiple pages. Get the next/previous pages of data when either the up or down arrow on the hat switch is pressed, or particularly defined up and down links are pressed. These links may have href's of either javascript:pageUp or javascript:pageDown, which may be defined as empty functions in the HTML files downloaded from application server 208, and are therefore customized for use with Customized web browser 202.

An example of a page that would be flagged as “get fresh” at step 270 is the weather page, which may have more current weather information than what was retrieved earlier in the day. The same process of modifying the page for local use needs to be executed when these files are fetched. If there is no connection to the Internet, however, the previously downloaded version is used.

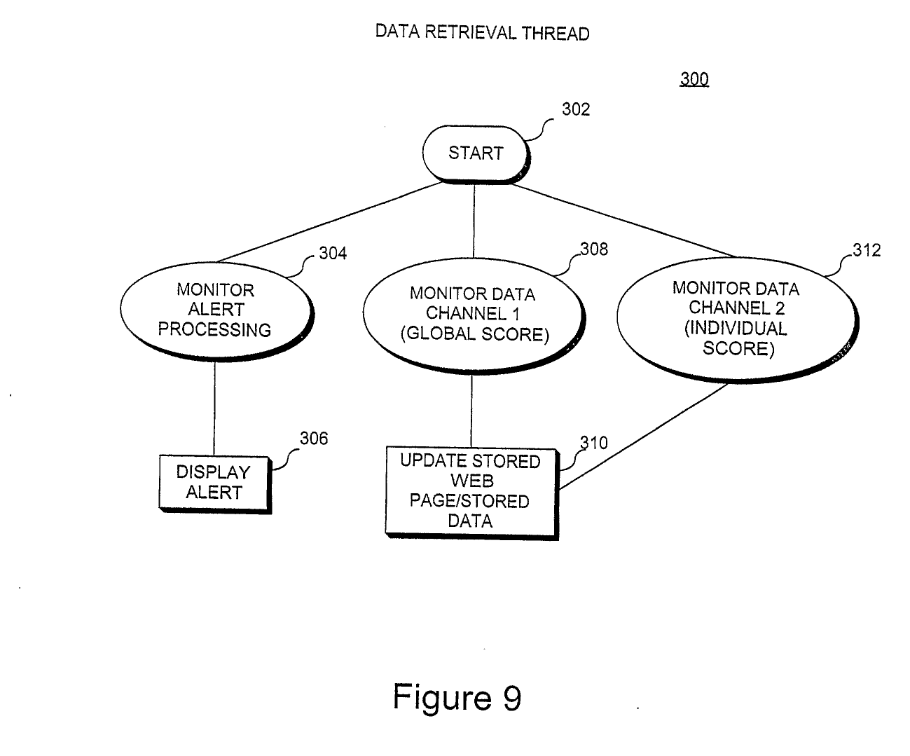

Preferably, the downloading and conversion of new data is provided by the data retrieval thread 230 depicted on FIG. 6. Data retrieval thread 300, depicted in more detail in FIG. 9, is thus separate from the browser thread, which preferably is used for navigation and user interface response and display. Preferably, data retrieval thread 300 is responsible for establishing and maintaining three or more separate communication channels with application server 208: an alert processing channel 304, a first data channel 308 (e.g., to update data concerning scoring), and a second data channel 312 (e.g., to update date concerning an individual).

There are several different data events that are handled in data retrieval thread 300, but the important thing about data retrieval in this application is that it should not hinder navigation. One difficult side effect of the Pocket PC environment is that many of the nicer programmatic features from a full-sized operating system are not available. Error recovery and exception handling are notable omissions. A result of this is that incorrect URL's or lack of connectivity can result in application crashes. The solution is to limit the time given to a retrieval request and terminate the request if there is no timely response. This can severely affect the user experience if these delays are in the main processing thread.

Preferably, data retrieval thread 300 is an endless loop that performs a variety of functions. By using counters to control how often each function is called, the frequency can be closely controlled. The browse application will access a data channel to update a particular page, if that page is one that has an associated data channel (e.g., steps 308, 310, 312), but it will also regularly check for alert messages and process the alert scrolling (at a much higher frequency) (steps 304, 306).

Whereas the browser thread is event-driven after the initial startup process is completed, in a preferred embodiment the data retrieval thread 300 has the following repeating algorithm:

```
while (theApp.m_dataChannelThreadOK) {
  if ((theApp.m_threadModCount++ % 70) == 0) {
    ::EnterCriticalSection (&theApp.m_dataChannelSection);
    URLLookup *currentURL = theApp.m_currentURL;
    ::LeaveCriticalSection (&theApp.m_dataChannelSection);
    if (currentURL)
      switch (currentURL->channelType) {
        case cCURRENT_SCORE_CHANNEL:
        sprintf (buff, “%s&pn=%i”, currentURL->channelString,
        currentURL->pageNumber);
        if (theApp.GetChannelData (pXMLHttp, pXMLDoc, buff,
        L“\\curr.xml”)) {
          theApp.StoreCurrentScores (pXMLDoc, currentURL);
          ::SendMessage (ghWnd, WM_TIMER,
          TIMER_CURR_DATA,
                        (long)currentURL);
        }
        break;
      case cINDIVIDUAL_SCORE_CHANNEL:
        strcpy (buff, currentURL->channelString);
        if (theApp.GetChannelData (pXMLHttp, pXMLDoc, buff,
        L“\\indv.xml”)) {
          theApp.StoreIndividualScores (pXMLDoc, currentURL);
          ::SendMessage (ghWnd, WM_TIMER,
          TIMER_INDV_DATA,
                        (long)currentURL);
        }
        break;
      }
  }
  if ((theApp.m_chargeModCount++ % 130) == 0) {
    sprintf (buff,
    “GolfPDAChannelServlet?cmd=GetGolfAlertStatus&lrd=%i”,
theApp.m_lastAlertTime);
    if (theApp.GetChannelData (pXMLHttp, pXMLDoc,
    buff, L“\\alert.xml”))
      theApp.StoreAlerts (pXMLDoc);
  }
  theApp.ProcessChargeScroll ( );
  Sleep (200);
}
```

The assignment of the currentURL variable from the global is done within a “critical section” so that the browser thread cannot change this value while the assignment is being made. This local variable is a pointer to the current URL entry in the URLLookup table, and used for the processing of this iteration of the loop. The timing of each type of processing done in this loop is controlled by two separate counters. The frequency of each iteration is set by the Sleep (200) call, which is a 200 millisecond delay inserted after each iteration. So, the m_threadModCount % 70 essentially sets the frequency of the data channel pulls at 14 seconds (plus processing time). And the alert processing is done very 26 seconds. ProcessChargescroll, which scrolls a string of text across the top of the screen, is called every 200 milliseconds, approximately. This routine moves one character at a time across the screen if there is alert information to display.

The GetChannelData calls return true if data is available. This is data retrieved from the data channel servlet (running on application server 208) in XML form. The XMLHTTP object has the async flag set to TRUE, so that we can monitor the connection. A WaitForResponse routine is used to do this. If 18 seconds have elapsed since the request was made, the request is aborted and a FALSE status is returned, as shown in the example below:

```
BOOL CMylbApp::WaitForResponse (IXMLHTTPRequest *pXMLHttp)
{
    long status;
    long startTime = ::GetTickCount ( );
    pXMLHttp->get_readyState (&status);
    while (status != 4) {
        pXMLHttp->get_readyState (&status);
        if (::GetTickCount ( ) - startTime > 18000) {
            pXMLHttp->abort ( );
            break;
        }
    }
    return status == 4;
}
```

Returning once more to FIG. 5, a channel servlet running on application server 208 may be used to retrieve XML-formatted data and content from the application server 208. The alert channel established by the data retrieval thread 300 thread in browser 202 may also be used to pull and monitor system alerts, formatted as XML content, from application server 208, via the same XMLHTTP and XMLDOM objects as those used in the example above. An exemplary XML alert response is as follows:

<ggas><cd>12332545346</cd><ct/><asw/></ggas>

The cd element is the timestamp of this message, which is used in subsequent channel calls (“give me all that is new on the alert channel since xxx”), and the ct and asw are different alert text elements, if available. If there was a weather alert, for instance, it would show up in the asw element as the actual text. The XML is parsed, and in this case the data is moved into a structure for processing the alert by displaying it in an alert child window preferably created during the initialize sequence.

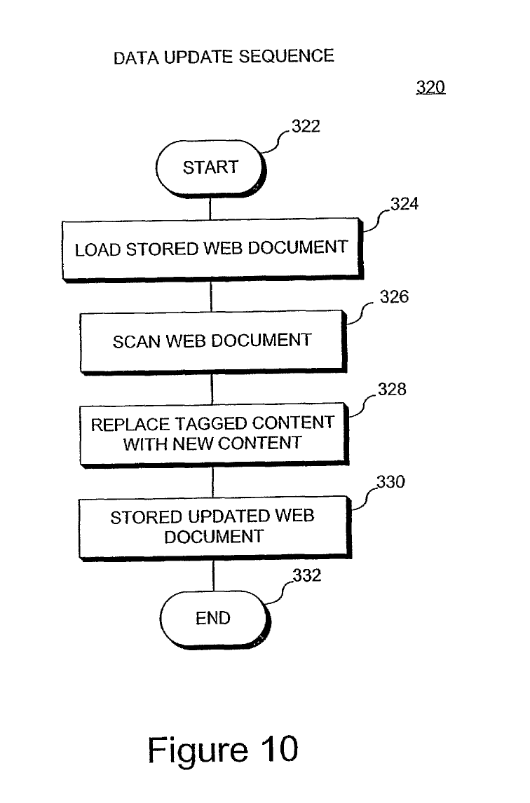

In order to minimize the quantity of data exchanged between the browser 202 and application server 208, it is preferable only to update web content that has changed since the time that the web content was last cached by device 100. Such updating is preferably carried out via two or more distinct data channels, as depicted in steps 308 and 312. With reference to FIG. 10, new content is received in step 323. Preferably, such content is received in XML format, as in the following example:

<ggcs>
<vgecs pid=”123” name=”Bobby Jones” eventScoreToPar=”E”
currentHole=”0” roundNumber=”1”
holeCount=”0” roundScoreToPar=”E”/>
... more player's scores ...
</ggcs>

Data retrieval thread 300 parses the XML content and stores the current information in a data structure that is compatible with placing it into the cached document. In the case of the current score page, the player's name may be stored as a hyperlink to their respective individual hole score, so the URL can change as the players' positions change over the course of the day. The data retrieval thread 300 also generates the appropriate URL for each row and any other manipulation.

After new content is received, data retrieval thread 300 updates the appropriate cached web page file images. If a cached web page file is not updated, then if the user navigates away from the page and then returns, he or she would see the page as it was at the (earlier) time that it was downloaded from the server. By constantly updating the cached file, the latest data is maintained. This updating may be carried out in a straightforward fashion by scanning each local file (depicted on FIG. 10 in steps 324 and 326) and replacing the data in coordination with the retrieved structure (steps 328 and 330).

The URL Lookup Table may beneficially be used in this data replacement process. Note that if an entry for a new URL is not found in the table, one must be added, and the file subsequently downloaded. If the file has already been downloaded, the local name is replaced into other files. This process can be recursive in the case that the file being added to the list is an HTML file, itself.

Once the data retrieval is completed, if the new retrieved content belongs to a web page that is actively being displayed on the screen of device 100, data retrieval thread 300 preferably sends a message to the browser thread to update the data in the “live” document. Yet another set of COM objects (e.g., Microsoft Document Object Module classes) may be used to update the currently-displayed image. Although the Microsoft DOM interfaces are designed to be used by the scripting languages, they are available to other applications as well. In the particular hardware and software environment described above as preferred embodiments, an interface object, IPIEHTMLDocument2, may be used as the entry point to the live document. This interface object is defined in the “webvw.h” file that is included as part of the Microsoft Pocket PC SDK, which provides a set of interfaces for accessing documents loaded in Pocket Internet Explorer. A pointer to the IPIEHTMLDocument2 object may be retrieved by first getting the IDispatch object from the HTMLControl, then using the standard QueryInterface to access the document object. These objects can only be manipulated by methods that are in the same thread as the HTMLControl, which is another reason to process the display updating in the main thread. A SendMessage is sent from the data channel thread to the main thread to initiate the display update process.

The technique of updating an HTML document in place, using a Document Object Model, is referred to as a “Data Island”, and is part of a current trend to separate the data elements from the display elements of a web page. The major advantage of this technique is that a relatively high frequency data update can be made by moving the minimal set of data. XML is a popular data description language, because of its extensibility, but the actual implementation of inserting data into the document varies. In a full Windows environment, each table element can be tagged such that the XML can be applied to a two-dimensional display in a few simple steps. In the Pocket PC environment in the above-described preferred embodiment, access by table tags is not supported.

A preferred technique for updating the cached documents in browser 202 is by using the DHTML (Dynamic Hypertext Markup Language) span tag. These tags can be placed anywhere in an HTML document and contain an id attribute. By placing these tag elements into an HTML table, for instance, a particular row/column location can be given a unique span i.d., and the contents of that cell can then be updated by calling the TPIEHTMLSpanElement object's put_innerText method. By coordinating the span tags with the retrieved data structure, the data display can be updated without loading a new page, or any user intervention. A further optimization is to first call the get_innerText method and compare the new value with the old, and only put the new data if different.

An example of this technique would be to start with the following HTML code:

```
  <table width=“232” border=“0” cellspacing=“0” bgcolor=“#FFFFFF”>
    <thead>
  <tr>
    <th width=“88” valign=“middle” class=“tiny”>Player</th>
    <th width=“41” valign=“middle” class=“tiny”>Tourn<br>Score</th>
    <th width=“28” valign=“middle” class=“tiny”>Hole</th>
  </tr>
</thead>
  <tr>
    <td align=“left” class=“tiny”><a href=‘is123.htm’>
        <span id=”link1”>Johnny Miller</span></a></td>
    <td class=“tiny”><span id=”score1”>23</span></td>
    <td class=“tiny”><span id=”hole1”>7</span></td>
  </tr>
</table>
```

The code to update one of the span tags may be as follows:

| | |
|---|---|
| 1. | void CMylbApp::SetValueToSpan (IPIEHTMLDocument2 |
| | *pHTMLDoc, WCHAR *id, WCHAR *value) |
| 2. | { |
| 3. | DISPID pid; |
| 4. | BSTR idBstr = SysAllocString (id); |
| 5. | HRESULT hr = pHTMLDoc->GetDispID (idBstr, 0, &pid); |
| 6. | if (hr == S_OK) { |
| 7. | VARIANT var; |
| 8. | IDispatch *pDispPlayer; |
| 9. | DISPPARAMS dispparamsNoArgs = {NULL, NULL, 0, 0}; |
| 10. | hr = pHTMLDoc->InvokeEx |
| | (pid, LOCALE_USER_DEFAULT, |
| | DISPATCH_PROPERTYGET, &dispparamsNoArgs, |
| | &var, NULL, NULL); |
| 11. | if (hr == S_OK) { |
| 12. | pDispPlayer = var.pdispVal; |
| 13. | IPIEHTMLSpanElement *pSpanPlayer; |
| 14. | hr = pDispPlayer->QueryInterface |
| | (IID_IPIEHTMLSpanElement, |
| | (void **)&pSpanPlayer); |
| 15. | if (hr == S_OK) { |
| 16. | BSTR existingValue; |
| 17. | hr = pSpanPlayer->get_innerText (&existingValue); |
| 18. | if (lstrcmp (existingValue, value)) { |
| | // if the date is different |
| 19. | BSTR ts = SysAllocString (value); |
| 20. | hr = pSpanPlayer->put_innerText (ts); |
| 21. | SysFreeString (ts); |
| 22. | } |
| 23. | SysFreeString (existingValue); |
| 24. | pSpanPlayer->Release ( ); |
| 25. | } |
| 26. | VariantClear (&var); |
| 27. | } |
| 28. | } |
| 29. | SysFreeString (idBstr); |
| 30. | } |

The various COM objects (IPIEHTMLDocument2, IPIEHTMLSpanElement, etc.) are defined in the system via a statement, include webvw.h . Updating the tagged elements is then just a matter of matching the retrieved data from the XML document (stored in the data structure by the data retrieval thread 300) with the span tags and repeatedly calling the SetValueToSpan method.

More particularly, the id parameter that is passed into this function corresponds to the span i.d. in the HTML code, and the value argument is the new value to be placed in the tag. Lines 3 through 5 above generate a pid value that can be then used to retrieve the span element. If the pid generation is successful (line 6), the InvokeEx method (from IDispatchEx) of the IPIEHTMLDocument2 is used to get an IDispatch pointer to the span element. To get the span element, the pointer (pDispPlayer) is queried for the IPIEHTMLSpanElement in line 14. The resulting pSpanPlayer pointer is used to get and set the “innerText”, or the data that exists between the start and end span tags. get_innerText is called in line 17 and that value is compared to the passed in value. If different, then the new value is inserted using the put_innerText call in line 20. The data update (calling the put_innerText) consumes enough CPU resources that its use should be minimized, especially on a page that contains a great deal of data elements. The various SysAllocString/SysFreeString and VariantClear calls are used to clean up the allocated memory of the BSTR (system-usable and allocated) strings.

A PDA-based customized browser application as described above has the following advantages over existing PDA-based browsers. First, the browser can function regardless of whether it is connected to the host server or not. Second, it allows the user to navigate through a web site in a reasonably responsive manner. Third, it is able to update the data on certain pages in a timely manner when connected. Fourth, if a connection to the host server is not available, it displays the most-recently retrieved data. Fifth and lastly, it works on currently available PDA devices, within existing constraints of memory, CPU power and battery life.

Having thus described particular embodiments of the invention, various alterations, modifications, and improvements will readily occur to those skilled in the art. Such alterations, modifications and improvements as are made obvious by this disclosure are intended to be part of this description though not expressly stated herein, and are intended to be within the spirit and scope of the invention.

Accordingly, the foregoing description is by way of example only, and not limiting. The invention is limited only as defined in the following claims and equivalents thereto.

What is claimed is:

1. A method for dissemination of information to a client device via a communications network, the method comprising:
receiving, at a client device, at least one file including content displayable via the client device, the file having been transmitted from a server device via the communications network;
parsing, at the client device, the at least one file to identify any external electronic addresses of referenced files, each external electronic address identifying a particular file and a corresponding network-accessible storage location that is external to the client device and accessible to said client device only via said communications network; and
modifying the at least one file to substitute a local electronic address for each external electronic address, the local electronic address identifying the respective particular file identified by the external electronic address and a corresponding storage location that is local to the client device.

2. The method of claim 1, further comprising:
retrieving each particular file, if any, via the communications network; and
storing each particular file in a memory of the client device.

3. The method of claim 2, further comprising:
displaying the at least one file via the client device, the displaying comprising retrieving from the memory of the client device at least one particular file that was formerly identified as accessible from only a corresponding network-accessible storage location that is external to the client device.

4. The method of claim 3, wherein the displaying is performed responsive to a user's selection of a hyperlink in a web browser application running on the client device.

5. The method of claim 4, wherein the displaying is performed while a network connection is unavailable to the client device, the retrieving of each particular file being performed while a network connection is available to the client device.

6. The method of claim 2, further comprising:
Communicating with said server device to determine whether a newly revised version is available for each particular file;
retrieving the newly revised version, if any; and
storing the newly revised version in the memory of the client device in substitution for a previously stored version of a corresponding file.

7. A method for dissemination of information to a client device via a communications network, the method comprising:
receiving, at the client device, at least one file including content displayable via the client device, the file having been transmitted from a server device via the communications network, the file including at least one external electronic address identifying a particular file and a corresponding network-accessible storage location that is external to the client device and accessible to said client device onl via said communications network; and
converting the at least one file to run locally by substituting a local electronic address for each external electronic address, the local electronic address providing a storage location local to the client device from which the respective particular file may be retrieved.

8. The method of claim 7, further comprising:
storing the at least one file, as converted to run locally, in a memory of the client device.

9. The method of claim 7, further comprising:
retrieving via the communications network the particular file; and
storing the particular file in a memory of the client device.

10. The method of claim 9, further comprising:
displaying the at least one file via the client device, the displaying comprising retrieving from the memory of the client device at least one particular file that was formerly identified as accessible from only a corresponding network-accessible storage location that is external to the client device.

11. The method of claim 7, wherein the receiving comprises downloading a web page file to the client device, the method further comprising downloading each particular file referenced by each external electronic address included in the web page file, the downloading being performed while a network connection is available to the client device.

12. The method of claim 11, wherein the downloading is performed before a request from a user to display the web page file via the client device.

13. The method of claim 12, further comprising:
displaying the web page file via the client device, the displaying comprising retrieving from a memory of the client device at least one particular file that was formerly identified as accessible from only a corresponding network-accessible storage location that is external to the client device, the displaying being performed while a network connection is unavailable to the client device.

14. A method for dissemination of information to a client device via a communications network, the method comprising:
receiving at the client device via the communication network, at least one file including content displayable via the client device, the file having been transmitted by a server device via the communications network;
parsing, at the client device, the at least one file to identify any external electronic addresses of referenced files, each external electronic address identifying a particular file and a corresponding network-accessible storage location that is external to the client device and accessible to said client device only via said communications network;
retrieving, via the communications network, each particular file;
storing each particular file in a memory of the client device;
creating a lookup table identifying a local electronic address for each particular file's corresponding external electronic address, the local electronic address identifying a corresponding storage location in the memory of the client device from which the respective particular file may be retrieved;
displaying the at least one file via the client device, the displaying comprising, for each respective particular file:
retrieving the respective particular file via the communications network using the external electronic address, if a network connection is presently available; and
retrieving the respective particular file from the memory of the client device using the local electronic address, if the network connection is presently unavailable.

15. The method of claim 14, further comprising:
receiving at the client device via the communication network, a new file;
scanning the new file to identify a DHTML span tag having a corresponding ID attribute and value;
scanning at least one file stored in the memory of the client device to identify a corresponding DHTML span tag having the same ID attribute; and
replacing a value corresponding to the span tag's ID attribute in the file stored in the memory with the value corresponding to the span tag's ID attribute in the new file if the respective values are different.

16. A method for dissemination of information to a client device via a communications network, the method comprising:
receiving, at a client device, at least one file including content displayable via the client device as part of a web page, the file being stored by a server device, the file including at least one external electronic address identifying a storage location external to the client device and accessible to the client device only via the communications network, the external electronic address being usable to retrieve a support file for the web page;
retrieving the support file from the storage location external to the client device, the retrieving involving communication via the communications network;
storing the support file in a memory of the client device;
converting the at least one file to run locally by modifying the at least one file to cause the support file to be retrieved from the memory of the client device instead of via the communications network when the support file is needed to display the web page; and
storing the at least one file, as modified, in the memory of the client device.

17. The method of claim 16, the converting comprising:
substituting a local electronic address for each external electronic address, the local electronic address providing a storage location local to the client device from which the respective particular file may be retrieved.

18. The method of claim 16, further comprising:
displaying the at least one file via the client device, the displaying comprising retrieving the support file from the memory of the client device.

19. A system for dissemination of information via a communications network, the system comprising:
a server device, said server device comprising:
a microprocessor;
a memory;
a network adapter for communicating via a communications network; and
an information content file stored in the memory; and
a client device, said client device comprising:
a microprocessor;
a memory;
a network adapter for communicating via the communications network; and
computer-readable program code stored in the client device's memory and executable by the client device's microprocessor to:
receive, at a client device, at least one file including content displayable via the client device as part of a web page, said file being transmitted from a server device, said file including at least one external electronic address identifying a storage location external to said client device and accessible to said client device only via the communications network, said external electronic address being usable to retrieve a support file for said web page;
retrieve said support file from said storage location external to said client device, said retrieving involving communication via the communications network;
store said support file in a memory of the client device;
convert said at least one file to run locally by modifying said at least one file to cause said support file to be retrieved from said memory of the client device instead of via the communications network when said support file is needed to display said web page; and
store said at least one file, as modified, in said memory of the client device.

20. The system of claim 19, further comprising:
an antenna in communication with said server device and said client device for transmitting such information from the server device to the client device via wireless transmission.

21. The system of claim 19, wherein said computer-readable program code configured to convert said at least one file to run locally comprises computer-readable program code configured to substitute a local electronic address for each external electronic address, said local electronic address providing a storage location local to the client device from which the respective particular file may be retrieved.

22. The system of claim 19, wherein said computer-readable program code stored in the client device's memory and executable by the client device's microprocessor further comprises:
computer-readable program code configured to display said at least one file via the client device, said displaying comprising retrieving the support file from the memory of the client device.

23. A system for dissemination of information via a communications network, the system comprising:
a server device, said server device comprising:
a microprocessor;
a memory;
a network adapter for communicating via a communications network; and
an HTML document file stored in said memory including at least one DHTML span tag, said span tag having a corresponding ID attribute and value; and
a client device, said client device comprising:
a microprocessor;
a memory;
a network adapter for communication with said server device via the communications network;
at least one file stored in the client device's memory; and
computer-readable program code stored in the client device's memory and executable by the client device's microprocessor to:
scan the new file to identify a DHTML span tag having a corresponding ID attribute and value;
scan the at least one file stored in the memory of the client device to identify a corresponding DHTML span tag having the same ID attribute; and
replace a value corresponding to the span tag's ID attribute in the file stored in the memory with the value corresponding to the span tag's ID attribute in the new file if the respective values are different.

24. The system of claim 23, further comprising:
an antenna in communication with said server device and said client device for transmitting such information from the server device to the client device via wireless transmission.

25. A client device for dissemination of information via a communications network, the client device comprising:
a microprocessor;
a memory;
a network adapter for communication via the communications network; and
computer-readable program code stored in the client device's memory and executable by the client device's microprocessor to carry out the method of claim 1.

26. A client device for dissemination of information via a communications network, the client device comprising:
a microprocessor;
a memory;
a network adapter for communication via the communications network; and
computer-readable program code stored in the client device's memory and executable by the client device's microprocessor to carry out the method of claim 7.

27. A client device for dissemination of information via a communications network, the client device comprising:
a microprocessor;
a memory;
a network adapter for communication via the communications network; and
computer-readable program code stored in the client device's memory and executable by the client device's microprocessor to carry out the method of claim 14.

28. A client device for dissemination of information via a communications network, the client device comprising:
a microprocessor;
a memory;
a network adapter for communication via the communications network; and
computer-readable program code stored in the client device's memory and executable by the client device's microprocessor to carry out the method of claim 16.

29. A client device for dissemination of information via a communications network, the client device comprising:
a microprocessor;
a memory;
a network adapter for communication via the communications network; and
computer-readable program code stored in the client device's memory and executable by the client device's microprocessor to carry out the method of claim 13.

30. A computer program product embodied on one or more computer-readable media, the computer program product adapted for dissemination of information to a client device via a communications network and comprising:
computer-readable program code configured to receive, at a client device, at least one file including content displayable via the client device as part of a web page, said file including at least one external electronic address identifying a storage location external to said client device and accessible to said client device only via the communications network, said external electronic address being usable to retrieve a support file for said web page;
computer-readable program code configured to retrieve said support file from said storage location external to said client device, said retrieving involving communication via the communications network;
computer-readable program code configured to store said support file in a memory of the client device;
computer-readable program code configured to convert said at least one file to run locally by modifying said at least one file to cause said support file to be retrieved from said memory of the client device instead of via the communications network when said support file is needed in connection with display of said web page; and
computer-readable program code configured to store said at least one file, as modified, in said memory of the client device.

31. The computer program product of claim 30, wherein said computer-readable program code configured to convert said at least one file to run locally comprises computer-readable program code configured to substitute a local electronic address for each external electronic address, said local electronic address providing a storage location local to the client device from which the respective particular file may be retrieved.

32. The computer program product of claim 30, further comprising:
computer-readable program code configured to display said at least one file via the client device, said displaying comprising retrieving the support file from the memory of the client device.
